(19) United States
(12) Patent Application Publication
(10) Pub. No.: US 2026/0257584 A1
(43) Pub. Date: Sep. 3, 2026

(54) Charging Method for a Secondary Battery and Vehicle

(71) Applicant: Mercedes-Benz Group AG, Stuttgart (DE)

(72) Inventors: Hendrik PEGEL, Stuttgart (DE); Dominik WYCISK, Stuttgart (DE); Alexander LUECK, Ludwigsburg (DE); Moritz PIEPER, Goettingen (DE)

(21) Appl. No.: 19/163,778

(22) PCT Filed: Feb. 8, 2024
(86) PCT No.: PCT/EP2024/053263

§ 371 Date: Sep. 9, 2025

(30) Foreign Application Priority Data
Mar. 10, 2023 (DE) 10 2023 000 904.0

(51) Int. Cl. B60L 58/12; B60L 58/26; B60L 58/27; H01M 10/44; H01M 10/48; H02J 7/90; H02J 7/94

(52) U.S. Cl. CPC B60L 58/12; B60L 58/26; B60L 58/27; H01M 10/443; H01M 10/486; H02J 7/933; H02J 7/94; H02J 7/977; B60L 2240/545

(57) ABSTRACT

A charging method for a secondary battery includes charging a galvanic cell with a cooling system deactivated for as long as the cell temperature at a potentially hottest point of the galvanic cell is less than a defined activation temperature, where the defined activation temperature depends on a cell type and a starting temperature of the galvanic cell when the charging process is started, charging the galvanic cell with the cooling system switched to full load as soon as the cell temperature at the potentially hottest point reaches the defined activation temperature, and, as soon as a temperature change of the cell temperature at the potentially hottest point reaches zero: reducing a cooling capacity of the cooling system and controlling the cooling capacity such that the cell temperature at the potentially hottest point and/or at a potentially coldest point of the galvanic cell is kept substantially constant.

### BACKGROUND AND SUMMARY OF THE INVENTION

The invention relates to a charging method for a secondary battery of the type defined in detail herein and to a vehicle for carrying out the method.

The number of vehicles having an at least partially electrified drivetrain, electric vehicles for short, continues to rise. To store electrical drive power, typically traction batteries are typically installed in such electric vehicles. Whereas a combustion vehicle can be refuelled with liquid fuel at a fuel pump comparatively quickly, it takes longer to charge the traction battery at a charging station. Particularly during long journeys that are longer in distance than the range of the vehicle, one or more charging stops need to be made. Such compulsory breaks can be a nuisance for the person driving the vehicle. In addition, the available charging stations, for example at a motorway service station, may all be in use, in particular during holiday season, so that there is an additional need to wait for a charging station to become available. This gives rise to the need to provide methods and means that can be used to shorten the charging duration needed for carrying out a charging process.

The charging duration depends in this case on the charging power that can be obtained from the charging station. The greater the charging voltage and the charging current, the faster the charging of the traction battery of the vehicle with electrical drive energy. However, the vehicle or the corresponding traction battery needs to be designed in terms of technology for respective charging currents and charging voltages. During the charging process, the cells of the traction battery heat up on account of dissipation heat, which requires active cooling to be provided and, if necessary, the charging current to be reduced in order to prevent the battery cells from overheating. In addition, the maximum cell voltage may not be exceeded and the minimum anode voltage may not fall below the plating limit.

In the region of the plating limit, i.e., the anode potential limit, the cell current is limited at that place on the cell where there is the lowest temperature and thus the highest overvoltage. When charging processes are carried out, the following conflict of aims therefore arises: the hottest place on the battery cell, also referred to as a hotspot, may not exceed a stipulated maximum value, yet at the same time, the coldest place on the battery cells, also referred to as a coldspot, should be as warm as possible in order to minimize resistances and overvoltages. This leads to the conflict of aims of having to cool the individual cells of the traction battery as intensely and early as possible in order to prevent the permissible temperature of the active material from being exceeded, while at the same time, however, having to cool them as little and as late as possible in order to ensure that the coldspots are as warm as possible.

The inventor addresses this problem, inter alia, in the following paper: Hendrik Pegel, Dominik Wycisk, Alexander Scheible, Luca Tendera, Arnulf Latz, Dirk Uwe Sauer; Fast-charging performance and optimal thermal management of large-format full-tab cylindrical lithium-ion cells under varying environmental conditions; Journal of Power Sources, Volume 556, 2023, 232408; ISSN 0378-7753, https://doi.org/10.1016/j.jpowsour.2022.232408

The paper deals with the thermal management of lithium-ion cylindrical cells during charging processes. The aim is to determine, as a function of the battery state-of-charge and the starting temperature of the battery cell, that cell temperature above which a cooling of the cell should be activated in order to shorten the charging duration by using the highest possible charging current. This therefore answers the question as to how to effect cooling at the start of the charging process so that the hotspot temperature does not exceed the maximum value, but the coldspot temperature is as warm as possible. The results for the cell type analysed are shown in the form of a so-called cooling-and-heating map. This map shows the cell temperature arising in each case from the charging process above which the active cooling should be activated depending on the starting temperature. In addition, active heating of the battery cell can be advantageous at cold starting temperatures. For instance, the cooling-and-heating map shows, also depending on the starting temperature, when the active heating should be started, at which cell temperature it should be switched off and at which cell temperature the active cooling should then be activated.

CN 1 15 709 670 A also discloses a thermal management method for the charging process of a rechargeable battery and the hardware to be used for this purpose. The thermal management method provides for not cooling a rechargeable battery during the charging process in a first phase and switching on a cooling system for the rechargeable battery in a second phase, which is reached if there is a defined temperature difference between the hottest place in the rechargeable battery and a state-of-charge-dependent maximum temperature. In the process, the temperature of the cooling medium is controlled, in order to keep the temperature level of the rechargeable battery within a defined interval.

US 2016/0 082 860 A1 also discloses a method for managing the temperature of a battery in an electric vehicle. Here, heating or cooling for the battery is activated or deactivated depending on the comparison of a temperature gradient across the battery with a reference curve. The cooling capacity can be controlled as a function of the heat output by the battery.

Furthermore, DE 10 2018 221 088 A1 discloses a battery system for an electric vehicle and a method for operating same. The battery system comprises at least one battery module, the temperature of which can be adjusted by means of a heating device and a cooling device to a target temperature. To adjust the cooling capacity, the flow rate of the cooling medium can be changed.

In addition, DE 44 43 015 A1 discloses a method for operating high-temperature batteries. A controller is provided here which defines a temperature target value that depends on the state-of-charge of the battery and the output of a cooling apparatus, above which temperature target value cooling is activated for the battery. The temperature target value corresponds to a temperature, which results when the thermal capacity of the battery has been used up and in the case of the maximum constant current provided for the battery taking into account the maximum permissible battery temperature. The cooling capacity is determined taking account of the inlet and outlet temperature of the cooling medium.

The present invention is based on the object of specifying a charging method for the galvanic cells of a secondary battery, the method being improved even further in relation to the cited prior art.

A generic charging method for a secondary battery, wherein the charging current used for charging at least one galvanic cell of the secondary battery with electrical energy during the charging process is controlled taking account of at least one of the variables: maximum cell voltage, minimum anode voltage, cell temperature and/or maximum charging current, and the heat dissipated in the process is removed by means of a cooling system that is at least sometimes active during the charging process, is refined according to the invention by the following charging phases:
a) charging the cell with cooling system deactivated for as long as the cell temperature at the potentially hottest point of the cell is less than a defined activation temperature, wherein the activation temperature depends on the cell type and the starting temperature of the cell when the charging process is started;
b) charging the cell with cooling system switched to full load as soon as the cell temperature at the potentially hottest point of the cell reaches the defined activation temperature; and
c) as soon as the temperature change of the cell temperature at the potentially hottest point of the cell reaches zero: reducing the cooling capacity of the cooling system and controlling the cooling capacity in such a way that the cell temperature at the potentially hottest point of the cell and/or at the potentially coldest point of the cell is kept substantially constant: wherein
   the cell temperature is lowered in a defined state-of-charge range before the cell is fully charged.

The method according to the invention can be used to reduce the charging duration for galvanic cells of secondary batteries even further. As already mentioned in the introduction, the local temperatures of the active material of the cell determine the local resistance and therefore the local overvoltages. The potentially coldest point of the cell, referred to in the following as coldspot, thus limits the maximum usable charging current, since this is where the highest cell voltages are anticipated. The warmer the coldspot, the higher the cell currents that can be used to charge the cell. An increase in the charging current can be used to shorten the charging duration. The Applicant has recognized that this gives rise to the following question for charging processes: how should cooling be controlled at higher states-of-charge in the region of the plating limit so that the temperature of the coldspot does not fall unnecessarily during the charging process? As a further condition, it must be ensured that the maximum permissible temperature of the active material of the cell is not exceeded.

With the aid of the method according to the invention, it is possible to raise the coldspot temperature of the cell more quickly in comparison to known charging methods and to keep it at the highest possible level during the ongoing charging process while preventing the cell temperature at the potentially hottest point of the cell, also referred to in the following as hotspot, from exceeding the maximum temperature valid for the used active material of the cell. This makes it possible to use the highest possible charging current throughout the entire charging process, which shortens the charging duration accordingly.

The galvanic cell is preferably a lithium-ion cell. The cell can correspond to any design, for example a pouch cell; however, it is preferably designed as a cylindrical cell.

The charging current is controlled during the charging process according to proven methods. The method steps according to the invention relate to cooling the cell, and so the charging method according to the invention could also be referred to as a thermal management method.

The position of hotspot and coldspot varies depending on the geometric and technical design of the respectively used galvanic cell and the corresponding cooling system. Depending on the cell construction and housing material, in a cylindrical cell which is mounted on a cooling plate for cooling, the hotspot is situated, for example, on the inner upper ring of the active material and the coldspot on the outer lower ring of the active material in the area of contact with the cooling plate. The cell temperature can be measured at any place, i.e., in particular at the hotspot and at the coldspot, with the aid of temperature sensors or also additionally or alternatively computationally estimated with the aid of a simulation model of the galvanic cell. Analogously, the other physical parameters such as cell voltage and charging current can be determined experimentally using measuring devices and/or by means of computation model.

The charging phase a) makes it possible to heat up the coldspot temperature as quickly as possible, so that the anode potential limitation can be delayed for as long as possible and reduced as much as possible and in many cases higher charging currents can also be used as quickly as possible. Carrying out charging phase b) prevents the cell from heating up so much that its maximum permissible temperature range is reached or exceeded. It is crucial here to measure or determine the cell temperature at that point that is heated the most when the charging process is carried out, i.e., the hotspot temperature.

As the charging duration continues, it is necessary to adjust the cooling in such a way that the coldspot temperature can be increased even further if possible or at least kept constant, without the hotspot temperature exceeding the maximum permissible temperature of the active material in the process. Thus, during the charging process, the cell temperature would fall when cooling is effected with maximum cooling capacity, which should be avoided, however. To this end, the cooling capacity is reduced accordingly by carrying out charging phase c). The fact that the temperature change to the cell temperature reaches zero at the hotspot means that the cell does not heat up any further at this point but its temperature remains constant, at least at that moment. In the case of uncharged cooling at maximum cooling capacity, the sign would reverse and the hotspot would cool down. In order to detect this point in time, the measured or computationally estimated hotspot temperature is evaluated. Since the hotspot temperature can only be detected with difficulty by means of experiments for cylindrical cells typically used in the automotive industry, the computationally estimated hotspot temperature is typically used.

The point in time at which the temperature of the hotspot reaches the maximum and begins to fall, can also be determined in practice by deriving the time using any temperature sensors.

The hotspot temperature and/or coldspot temperature can itself be used directly as reference variable for the controlling the cooling capacity. However, a comparatively more complex controller is needed for this, since the control loop between cooling system and hotspot temperature is very complex due to the geometry, internal heat paths and already existing temperature gradients.

As already described above, the cell temperature is lowered in a defined state-of-charge range before full load is reached. If electrical energy is to be supplied by means of the secondary battery once the charging process has finished, the secondary battery or the one or more galvanic cells of the secondary battery can heat up further. This is the case particularly if a particularly high output is requested at short notice. As will be mentioned, the method according to the invention can be used for charging the traction battery of a vehicle. If the vehicle user exerts an intense load on the traction battery after the charging process has ended, for example due to a sporty driving style, there is the risk that the cells of the traction battery will be heated above the maximum permissible temperature. However, by lowering the cell temperature shortly before the end of the charging process, for example by increasing the cooling capacity again, a certain thermal buffer is thus provided, so that increased drive power can be used without the cells of the traction battery running the risk of overheating. The defined state-of-charge range before reaching full charge, in which the cell temperature is lowered, can be selected variably depending on the technical design of the traction battery and the charging station used, in particular the charging voltage and charging current used. For example, an engineer can stipulate that the cells of the traction battery are to be cooled to such an extent that after the charging process has ended the maximum usable drive power is to be provided for at least 10 minutes or at least the next three kilometres, without the risk of overheating. Corresponding state-of-charge ranges can then also be defined for different vehicle configurations and traction battery variants by means of tests and/or simulations. Lowering the cell temperature before the end of the charging process has the further positive effect that temperature-related ageing is slowed down or stopped. Although the charging duration then increases imperceptibly, this is no longer as significant towards end of the charging process.

One advantageous refinement of the method according to the invention thus provides that in order to control the cooling capacity:
the thermal output emitted by the cell is measured and/or computationally estimated;
the thermal output that can be or is removed by the cooling system is measured and/or computationally estimated; and
the cooling capacity is controlled in such a way that the thermal output that can be or is removed substantially corresponds to the thermal output emitted by the cell.

In addition to the thermal output of the cells, i.e., the main heat sources, the heat generation by the cell connectors and further secondary sources of heat generation can also advantageously be determined or estimated and this can be taken into account when the controlling the cooling capacity. As a result, the cooling capacity of the battery can be even better matched to the total heat generation of the battery and controlled accordingly.

This makes simple and robust control possible. The thermal output emitted by the cell is the heat dissipated during the charging process. In order to keep the cell at a constant temperature, the dissipated waste heat must therefore be removed/removed in accordance with the principles of the thermodynamics. If therefore the cooling capacity is adjusted to the emitted thermal output of the cells and the additional sources of heat, for example in conductive and contact elements, it is also possible to ensure that the hotspot temperature or coldspot temperature are kept substantially constant without the corresponding cell temperatures actually having to be measured, whereby the method according to the invention can also be implemented simply and cost-effectively for charging processes for cylindrical cells that are frequently installed in the automotive industry.

The thermal output emitted by the cell or the energy lost can be determined easily and comparatively accurately by means of the computational cell model. This energy lost can also be estimated particularly simply using the measured terminal voltage, the known open-circuit voltage and the measured operating current, although this is slightly less accurate than the estimate using the cell model.

The thermal output that can be removed by the cooling system can then also be approximated by means of a computation model. Particularly advantageously, however, the thermal output actually removed can also be determined by way of experiments.

In this way, the cooling capacity set by the controller can be corrected quickly and easily. A cascade control system is used, which is easy to implement, extremely robust and has delivered excellent results in tests.

It must be taken into account here that the battery system may have hundreds of cells and the cooling capacity is controlled such that even the cell that would reach the maximum temperature limit first is sufficiently cooled, that is to say, for example, a cell close to the coolant outlet, as the coolant is already preheated there. The required cooling capacity is therefore controlled to suit this cell.

In accordance with a further advantageous embodiment of the method according to the invention, the heat transfer coefficient between the interaction surface between cell and cooling system is adjusted in order to set the thermal output to be removed by the cooling system. The cell can be cooled using proven methods and processes. Heat can be removed in general by means of heat conduction, heat radiation and by convection. A convection-based cooling system is preferably used, particularly preferably one based on forced convection. By adjusting the heat transfer coefficients, the heat flow rate or thermal output to be removed can be set particularly conveniently and accurately. For example, the area wetted by a cooling medium, the mass flow rate of the cooling medium and/or the temperature of the cooling medium can be changed.

A fluid-based cooling system is preferably used, wherein cooling medium flows indirectly or directly across or around at least one section of the cell, and the volume flow rate of the cooling medium is controlled in order to adjust the heat transfer coefficient. This makes it particularly simple to control the cooling capacity.

Cylindrical cells attached to a cooling plate are frequently installed in vehicles. A liquid cooling medium flows through the cooling plate. The heat is accordingly removed through the base of the cylindrical cell. For indirect flow across the cell, a heat sink is therefore connected to the cell, which in turn is indirectly connected to the cell for example via thermal pads or thermal paste.

The cooled surface area of the cell is known and corresponds as mentioned above to the cross-sectional area of the cell base in the case of a cylindrical cell connected to a cooling plate. The fluid temperatures are measured at the coolant infeed and coolant return as standard. An average value of the infeed and return temperatures can also be used for the fluid temperature. The base temperature of the cell can also be measured or estimated by means of a computation model.

In accordance with a further advantageous embodiment of the method, the speed of a cooling medium delivery pump is controlled in order to adjust the volume flow rate of the cooling medium. This makes it even easier to control the volume flow rate in a more robust manner. In contrast to influencing the volume flow rate by, for example, opening and closing shutters or valves provided in the flow channel, this reduces flow losses and correspondingly saves drive energy for operating the cooling medium delivery pump. The response behaviour, i.e., the influencing of the volume flow rate by adjusting the speed is in addition particularly direct.

A further advantageous embodiment of the method according to the invention also provides that if the starting temperature of the cell is less than a defined heating temperature, the cell is actively heated at least sometimes during charging phase a), wherein a heater used for this purpose is switched off when a heating-deactivation temperature below the activation temperature is reached, and wherein the heating-deactivation temperature depends on the cell type and the starting temperature of the cell when the charging process is started. As mentioned above, the maximum usable charging current depends on the cell temperature and is upwardly limited by cold temperatures. At cold temperatures, in particular around or below freezing point, the charging process can thus only be carried out with a reduced charging current. However, if the cell is actively heated, the cell temperature at the coldspot increases correspondingly, so that charging can be carried out using higher charging currents, which shortens the charging duration even more. Here as well, depending on the geometry and technical design of the cell, different temperature limits are defined in terms of when the active heater should be switched on and when it should be switched off again to avoid overheating.

In accordance with a further advantageous embodiment of the method according to the invention, a computing unit for controlling the cooling system reads out the activation temperature from a cooling-heating map, wherein the cooling-heating map was initially created for the cell type used by carrying out measurements and/or simulations, wherein to determine the relationship between activation temperature and starting temperature for different starting temperatures, the cooling system was activated in each case at different cell temperatures and that cell temperature at which the charging time taken by the cell to reach the respective starting temperature is the shortest is defined as the activation temperature.

The appropriate point in time for activating the cooling system according to charging phase b) is of particular significance for reducing the charging duration. If the cooling system is switched on too early, valuable residual potential for increasing the charging current and therefore for shortening the charging duration is lost. The coldspot could heat up even further as a result and a higher charging current could accordingly be used. If, by contrast, the cooling system is activated too late, the current charging current must be reduced suddenly and steeply on reaching the permissible active material temperature at the hotspot in order to avoid further overheating. Thus any remaining potential for reducing the charging duration is also lost.

Accordingly, there are individual optimum values for different battery states-of-charge (SOC) at different starting temperatures in each case, at which the cooling system should be activated due to the cell temperatures arising in the charging process as a result of dissipation heat. These optimal temperatures are determined in the form of the activation temperature by means of a series of tests to be carried out beforehand. The method is analogous to the approach disclosed in the paper written by the inventor for determining the cooling-heating map. See in this regard also: Hendrik Pegel, Dominik Wycisk, Alexander Scheible, Luca Tendera, Arnulf Latz, Dirk Uwe Sauer; Fast-charging performance and optimal thermal management of large-format full-tab cylindrical lithium-ion cells under varying environmental conditions; Journal of Power Sources, Volume 556, 2023, 232408; ISSN 0378-7753, https://doi.org/10.1016/j.jpowsour.2022.232408.

A further advantageous embodiment of the method according to the invention furthermore provides that a computing unit for controlling the heater reads out the heating temperature and the heating-deactivation temperature from the cooling-heating map, wherein to determine the relationship between heating temperature, heating-deactivation temperature and starting temperature for different starting temperatures, the heater was activated and deactivated in each case at different cell temperatures and those cell temperatures at which the charging time taken by the cell to reach the respective starting temperature is shortest are defined as heating temperature and heating-deactivation temperature. The way in which the heating of the cell is carried out also has an effect on the charging duration. For instance, the cell should be heated up as quickly as possible so that in comparison high charging currents can be used as early as possible, which reduces the charging duration. The heater should thus be large enough in size. The starting temperature above which activating the heater is specified to have a positive influence on the charging duration, is determined analogously to the procedure for determining the activation temperature by means of a series of tests carried out initially. This gives rise to the question of when, i.e., at which cell temperature, to deactivate the heater again in order to maximize the cell temperature at the coldspot while avoiding overheating the hotspot in the process. By subsequent activation of the cooling system, even in the case of comparatively cold starting temperatures or ambient temperatures, the cell can be heated further than without subsequent cooling, whereby higher charging currents can be used more quickly. The question as to when to activate or deactivate the heater is also answered in conjunction with the series of tests to be carried out initially. In this respect, reference is once again made to the above-referenced paper written by the inventor.

In a vehicle comprising a traction battery, a cooling system and at least one control device, according to the invention the traction battery, the cooling system and the at least one control device are designed to carry out an above-described method. The vehicle can be any road vehicle, such as a car, lorry, van, bus or the like. It can also be a rail vehicle, watercraft or aircraft. To monitor the traction battery and to control the cooling system, one and the same control device can be used or also else different control devices. At least one control device can also be formed by the battery management system of the traction battery. By employing the method according to the invention, the vehicle according to the invention is able to shorten the charging duration of a charging process for charging the cells of the traction battery, which increases convenience for the vehicle user. According to the invention, the disclosed charging method is therefore used for charging the traction battery of a vehicle.

Further advantageous embodiments of the charging method according to the invention for a secondary battery will also become apparent from the exemplary embodiments, which are described in detail hereinafter with reference to the figures.

### BRIEF DESCRIPTION OF THE DRAWINGS

FIG. 1 shows a schematic sectional view of a galvanic cell of a secondary battery;

FIG. 2 shows a first diagram showing the cell voltage and anode voltage over time during a charging process of the galvanic cell, a second diagram showing the cell temperature at different positions of the cell and the C-rating of the cell over time during the charging process of the galvanic cell, and a third diagram showing the thermal output emitted by the cell during charging and the corresponding cooling capacity of a cooling system used for cooling the cell; and

FIG. 3 shows two diagrams, showing a cooling-heating map and the charging duration of the charging process, which is set in accordance with the starting conditions selected in the cooling-heating map for activating the cooling system.

### DETAILED DESCRIPTION OF THE DRAWINGS

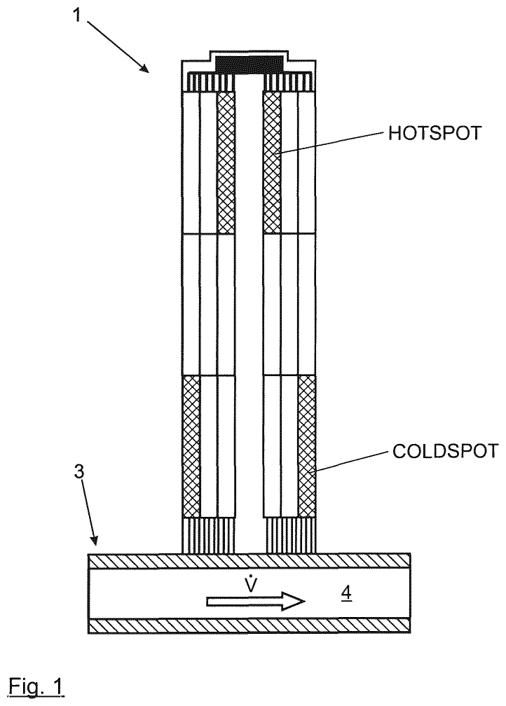

FIG. 1 shows a galvanic cell 1 used to form a secondary battery. By way of example, this is a lithium-ion cell designed as a cylindrical cell. For example, the cylindrical cell is of the 18650, 21700 or 46800 type. However, it could also be a pouch cell or the like. Multiple such cells 1 can also be connected together to form a battery module. One or more galvanic cells 1 form a secondary battery.

The galvanic cell 1 shown in FIG. 1 is charged by means of a charging method according to the invention. During charging, the galvanic cell 1 heats up. Dissipation heat that forms is removed by means of a cooling system. In FIG. 1, the galvanic cell 1 is mounted for this purpose on a cooling plate 3 which has at least one channel 4 for conducting a cooling medium at a volume flow rate V. In FIG. 1, the potentially coldest point COLDSPOT is in the lower, region of galvanic cell 1 facing the cooling plate 3, on the outer circumference. The potentially hottest point HOTSPOT is situated on the opposite free end of the galvanic cell 1 in the interior. The coldspot and hotspot regions shown in FIG. 1 usually only extend over a small area, in particular in the cell longitudinal direction, and the hotspot is only situated at the very upper inner edge and the coldspot at the outer lower edge of the cell.

The galvanic cell 1 is now charged by carrying out a charging method according to the invention. The thermal output to be removed by means of the cooling system is precisely controlled as a function of the charging phase controlled.

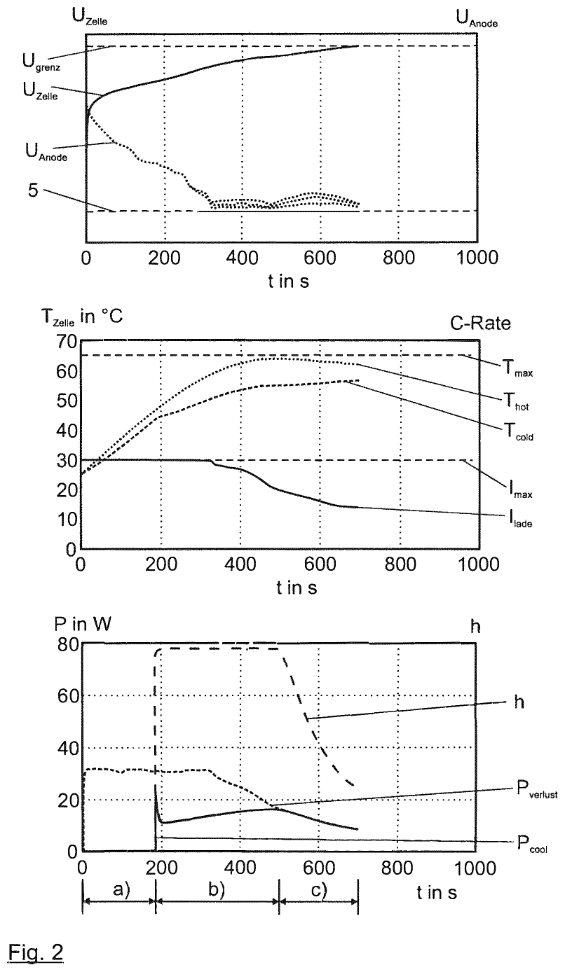

FIG. 2 shows in three diagrams the sequence of the charging method according to the inventions, which is divided into the three charging phases a), b) and c). The x-axis of the three diagrams shows in each case the time t. In the diagrams, some variables are shown qualitatively and some variables are shown quantitatively.

The upper diagram in FIG. 2 shows the cell voltage U_{cell} and the anode voltage U_{anode}. The full cell voltage limit Uₗᵢₘᵢₜ and the plating limit 5 are also plotted as horizontal lines. The middle diagram shows the cell temperature T_{cell} at different places and the C-rate of the cell 1. In addition, the overheating limit Tₘₐₓ and the current limit Iₘₐₓ are plotted as horizontal lines. The bottom diagram shows the thermal output Pₗₒₛₛ dissipated by the cell 1, the cooling capacity P_{cool} of the cooling system and the heat transfer coefficient h at the heat exchange surface between cell 1 and cooling system.

In the charging phase a), the cell 1 is charged with cooling system deactivated. In charging phase b), the cooling system is switched on with maximum cooling capacity P_{cool} and operated at full load. In charging phase c), the cooling capacity P_{cool} is controlled in such a way that the cooling capacity P_{cool} is reduced, meaning that the cell temperatures T_{cell} of the potentially hottest point HOTSPOT or potentially coldest point COLDSPOT of the galvanic cell 1 remain substantially constant. In the exemplary embodiment shown, the hotspot temperature Tₕₒₜ remains substantially constant and the coldspot temperature T_{cold} increases continually. The charging current I_{charge} is controlled on the basis of already known typical charging methods and first of all runs at the maximum value of the current limit Iₘₐₓ and is then reduced as the charging duration advances. In order to control the cooling capacity P_{cool}, either control based on the measured hotspot temperature Tₕₒₜ can be effected, or else power-based control in which the cooling capacity P_{cool} corresponds to the dissipated thermal output Pₗₒₛₛ of the galvanic cell 1. Therefore, dissipated and removed heat retain a balance, so that the temperature state of the galvanic cell 1 remains substantially constant.

The top diagram shows that as the charging duration advances, the cell voltage U_{cell} increases continually. The cell 1 is charged. In this case, the anode voltage U_{anode} continually falls until just before reaching the plating limit 5. Several curves of the anode voltage U_{anode} from different simulations are plotted here. To ensure the shortest charging duration, the anode voltage U_{anode} should be conducted along the plating limit 5, as is the case here. The plating limit 5 is theoretically 0 mV, with it also being controlled to just over 0 mV for safety reasons. The cell 1 can therefore be operated continuously at the anode potential limit, i.e., the plating limit 5, with the highest possible coldspot temperature T_{cold} and minimum overvoltages.

As is apparent from the middle diagram, the hotspot temperature Tₕₒₜ is controlled as close as possible to the overheating limit Tₘₐₓ, so that overheating of the active material of the cell 1 is reliably prevented. By lowering the cooling capacity P_{cool} in charging phase c), cooling of the potentially coldest point COLDSPOT at high states-of-charge is avoided. On the contrary, the coldspot temperature T_{cold} even rises, whereby the locally limited resistance falls and thus a higher charging current I_{charge} can be used to carry out the charging process. In addition, in charging phase c) the hotspot temperature Tₕₒₜ falls somewhat, thereby creating a buffer with respect to the overheating limit Tₘₐₓ. In addition, a slight temperature gradient remains inside the cell 1 which is not completely eliminated, so that the cell 1 can quickly be cooled to regular operating temperatures again after the charging process.

The lower diagram shows the curve of the heat Pₗₒₛₛ dissipated by the cell 1 during the charging process, or rather thermal output. When changing from charging phase a) to charging phase b), the cooling system is switched to full load. This accordingly gives rise to the maximum possible heat transfer coefficient h and this is maintained during charging phase b). The heat removed by the cooling system, i.e., the cooling capacity P_{cool}, initially rises very quickly to its maximum value, then falls again and rises again slowly until the end of charging phase b). In charging phase c), the cooling capacity P_{cool} is calibrated to the dissipation heat output Pₗₒₛₛ. The cooling system is therefore controlled in such a way that the hotspot temperature Tₕₒₜ remains substantially constant. To this end, by reducing the speed of the cooling medium delivery pump, the volume flow rate of the liquid cooling medium is reduced, whereby the heat transfer coefficient h drops. The heat transfer coefficient h is therefore controlled such that the thermal flow that is removed by the cooling medium across the system limit corresponds exactly to the heat generation of the cell 1 in accordance with the cooling capacity P_{cool}. Potential sources of heat in the cell housing and any cell connectors can also be taken into account here.

By splitting the charging process into the charging phases a), b) and c), it is possible to shorten the charging time for the entire charging duration by providing the respectively maximum charging current I_{charge}.

Whereas charging phase c) allows the charging duration to be shortened towards the end of the charging process, i.e., in the range of higher battery states-of-charge, the charging phases a) and b) make it possible to accelerate the charging duration at the start of and in the middle of the charging process. According to the invention, merely charging phase c) on its own can shorten the charging duration. Phase c) is particularly useful at high temperatures, in order to avoid unnecessary cooling down. This is primarily the case with higher states-of-charge with a corresponding warming-up, but can also occur in certain cases at low states-of-charge if the temperature limit is reached early in the case of a high starting temperature, although the state-of-charge is still low.

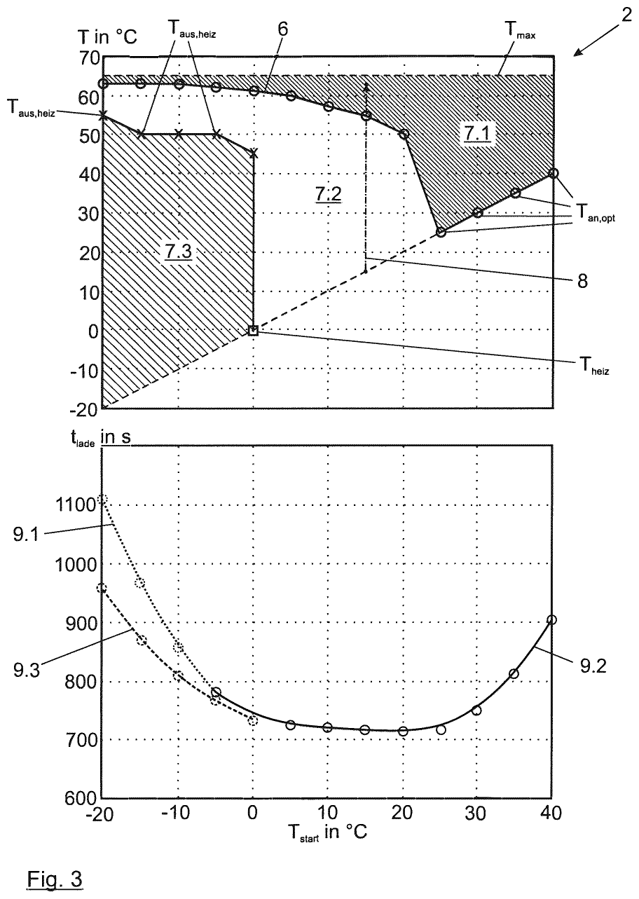

However, the question also arises as to when, i.e., at which cell temperature T_{cell}=Tₕₒₜ caused by the charging, it is best to switch from charging phase a) to charging phase b). In general, any activation temperature T_{on,opt} can be considered to this purpose (see FIG. 3). For the sake of clarity, in FIG. 3 only some points have been given the corresponding reference signs. However, there is an optimum temperature point for the cell temperature T_{cell}, above which the cooling system should be activated to full load. If activation is too early, the potentially coldest point COLDSPOT is still not sufficiently heated, so that in comparison there is a greater electrical resistance and thus only a lower charging current I_{charge} can be used to prevent overvoltages. If, by contrast, the cooling system is activated too late, i.e., there is a wait until the cell temperature T_{cell} is even higher, the potentially hottest point HOTSPOT runs the risk of overheating, meaning that the charging current I_{charge} must be suddenly and rapidly reduced for sufficient cooling down, whereby the charging duration also increases again.

The relationship between the optimum activation temperature T_{on,opt} and the respective starting temperature Tₛₜₐᵣₜ is elucidated with reference to FIG. 3. The starting temperature Tₛₜₐᵣₜ correlates in this case with the surrounding temperature. It is therefore assumed that the cell temperature T_{cell} corresponds to the surrounding temperature. The cooling-heating map 2 shown in FIG. 3 is then generated using a series of tests and/or simulations. This map shows the starting temperature Tₛₜₐᵣₜ on the x-axis and different temperatures T on the y-axis. In this case, multiple charging processes are carried out for respective different starting temperatures Tₛₜₐᵣₜ, wherein charging is carried out for a respective starting temperature Tₛₜₐᵣₜ until different cell temperatures T_{cell} are reached at which the cooling system is then activated. A curve 6, which marks optimum activation temperature T_{on,opt} for the respective starting temperature Tₛₜₐᵣₜ is plotted in the cooling-heating map 2.

The following should be noted: The diagrams shown in FIG. 3 merely refer to determining the optimum activation temperature T_{on,opt} as a function of starting temperature Tₛₜₐᵣₜ. Thus, to determine the information shown in FIG. 3, the cooling capacity is not controlled in the charging phase c), but this continues to be operated at maximum. This corresponding charging duration t_{charge} shown in FIG. 3 in the lower diagram is therefore influenced only by the choice of the activation temperature T_{on,opt}. This allows a possible influence, caused by controlling the cooling capacity P_{cool} in charging phase c), on the determination of the optimum activation temperature T_{on,opt} to be ignored.

The cooling-heating map 2 is divided into three regions 7.1, 7.2 and 7.3. The cooling system is operated in the region 7.1. Neither the cooling system nor a heating system is operated in the region 7.2. A heater is used to preheat the cell 1 in the region 7.3, which is then switched off above a heating-deactivation temperature T_{off,heat}.

Above a starting temperature Tₛₜₐᵣₜ of approx. 25° C., the cooling system is switched to full load directly at the start of the charging process. The duration of charging phase a) is therefore 0 seconds in this case.

The diagram is to be interpreted as follows: The starting temperature Tₛₜₐᵣₜ of the galvanic cell 1 is shown. As a result of starting the charging process, the galvanic cell 1 heats up, so that there is a rise in the cooling-heating map 2 to hotter temperatures. This is illustrated by way of example by an arrow 8 for a starting temperature Tₛₜₐᵣₜ of 15° C.

By contrast, for- 10°, for example, this means that additionally the region 7.3 is also passed though. This means that the heater is also activated when the charging process is started. Charging continues and the heater is operated until the heating-deactivation temperature T_{off,heat} is reached. The limit between the regions 7.2 and 7.3 is characterized in this case by a heating temperature Tₕₑₐₜ. When the heating-deactivation temperature T_{off,heat} is reached, the heater is deactivated and the region 7.2 is entered. Charging continues until the activation temperature T_{on,opt} is reached. Also shown is the overheating limit Tₘₐₓ, and the cooling prevents the cell temperature T_{cell} from exceeding this limit.

As is apparent in FIG. 3 in the lower diagram, particularly in the case of cold starting temperatures Tₛₜₐᵣₜ, the charging duration can be shortened. A curve 9.1 shows the charging duration when the cooling system is controlled as standard, when no cooling is needed. A curve 9.2 shows the charging duration that arises when the cooling system, as described, is switched to the respective activation temperature T_{start,opt} (without heating). A curve 9.3 shows the charging duration that arises with prior heating of the cell 1.

To further improve the charging duration, the cooling system is therefore controlled in charging phase c) (not shown in FIG. 3) on the basis of the findings shown in FIG. 3.

1.-9. (canceled)

10. A charging method for a secondary battery, wherein a charging current (I_{charge}) used for charging a galvanic cell (1) of the secondary battery with electrical energy during a charging process is controlled taking account of at least one of a variable of: maximum cell voltage, minimum anode voltage, cell temperature (T_{cell}) and/or maximum charging current, and wherein heat dissipated in the charging process is removed by a cooling system that is at least sometimes active during the charging process, comprising the steps of:
a) charging the galvanic cell (1) with the cooling system deactivated for as long as the cell temperature (T_{cell}) at a potentially hottest point (HOTSPOT) of the galvanic cell (1) is less than a defined activation temperature (T_{on,opt}), wherein the defined activation temperature (T_{on,opt}) depends on a cell type and a starting temperature (Tₛₜₐᵣₜ) of the galvanic cell (1) when the charging process is started;
b) charging the galvanic cell (1) with the cooling system switched to full load as soon as the cell temperature (T_{cell}) at the potentially hottest point (HOTSPOT) of the galvanic cell (1) reaches the defined activation temperature (T_{on,opt}); and
c) as soon as a temperature change of the cell temperature (T_{cell}) at the potentially hottest point (HOTSPOT) of the galvanic cell (1) reaches zero: reducing a cooling capacity (P_{cool}) of the cooling system and controlling the cooling capacity (P_{cool}) such that the cell temperature (T_{cell}) at the potentially hottest point (HOTSPOT) of the galvanic cell (1) and/or at a potentially coldest point (COLDSPOT) of the galvanic cell (1) is kept substantially constant;
wherein the cell temperature (T_{cell}) is lowered in a defined state-of-charge range before the galvanic cell (1) is fully charged.

11. The method according to claim 10, wherein to control the cooling capacity (P_{cool}):
a thermal output (Pₗₒₛₛ) emitted by the galvanic cell (1) is measured and/or computationally estimated;
a thermal output that is removable or is removed by the cooling system is measured and/or computationally estimated; and
the cooling capacity (P_{cool}) is controlled such that the thermal output that is removable or is removed by the cooling system substantially corresponds to the thermal output (Pₗₒₛₛ) emitted by the galvanic cell (1).

12. The method according to claim 10, wherein a heat transfer coefficient between an interaction surface between the galvanic cell (1) and the cooling system is adjusted in order to set a thermal output to be removed by the cooling system.

13. The method according to claim 12, wherein a fluid-based cooling system is used, wherein cooling medium flows indirectly or directly across or around at least one section of the galvanic cell (1), and a volume flow rate of the cooling medium is controlled in order to adjust the heat transfer coefficient.

14. The method according to claim 13, wherein a speed of a cooling medium delivery pump is controlled in order to adjust the volume flow rate of the cooling medium.

15. The method according to claim 10, wherein, when the starting temperature (Tₛₜₐᵣₜ) of the galvanic cell (1) is less than a defined heating temperature (Tₕₑₐₜ), the galvanic cell (1) is actively heated at least sometimes during step a), wherein a heater for actively heating the galvanic cell (1) is switched off when a heating-deactivation temperature (T_{off,heat}) below the defined activation temperature (T_{on,opt}) is reached, and wherein the heating-deactivation temperature (T_{off,heat}) depends on the cell type and the starting temperature (Tₛₜₐᵣₜ) of the galvanic cell (1) when the charging process is started.

16. The method according to claim 10, wherein a computing unit for controlling the cooling system reads out the defined activation temperature (T_{on,opt}) from a cooling-heating map (2), wherein the cooling-heating map (2) was initially created for the cell type used by carrying out measurements and/or simulations, wherein to determine a relationship between activation temperature (T_{on,opt}) and starting temperature (Tₛₜₐᵣₜ) for different starting temperatures (Tₛₜₐᵣₜ), the cooling system was activated in each case at different cell temperatures (T_{cell}) and that cell temperature (T_{cell}) at which the charging time (t_{charge}) taken by the galvanic cell (1) to reach the respective starting temperature (Tₛₜₐᵣₜ) is the shortest is defined as the activation temperature (T_{on,opt}).

17. The method according to claim 16, wherein, when the starting temperature (Tₛₜₐᵣₜ) of the galvanic cell (1) is less than a defined heating temperature (Tₕₑₐₜ), the galvanic cell (1) is actively heated at least sometimes during step a), wherein a heater for actively heating the galvanic cell (1) is switched off when a heating-deactivation temperature (T_{off,heat}) below the defined activation temperature (T_{on,opt}) is reached, and wherein the heating-deactivation temperature (T_{off,heat}) depends on the cell type and the starting temperature (Tₛₜₐᵣₜ) of the galvanic cell (1) when the charging process is started;
wherein a computing unit for controlling the heater reads out the defined heating temperature (Tₕₑₐₜ) and the heating-deactivation temperature (T_{off,heat}) from the cooling-heating map (2), wherein to determine a relationship between heating temperature (Tₕₑₐₜ), heating-deactivation temperature (T_{off,heat}) and starting temperature (Tₛₜₐᵣₜ) for different starting temperatures (Tₛₜₐᵣₜ), the heater was activated and deactivated in each case at different cell temperatures (T_{cell}) and those cell temperatures (T_{cell}) at which the charging time (t_{charge}) taken by the galvanic cell (1) to reach the respective starting temperature (Tₛₜₐᵣₜ) is the shortest are defined as heating temperature (Tₕₑₐₜ) and heating-deactivation temperature (T_{off,heat}).

18. A vehicle, comprising:
a traction battery;
a cooling system; and
a control device;
wherein the traction battery, the cooling system, and the control device are configured to perform the method according to claim 10.
